(19) United States
(12) Patent Application Publication
(10) Pub. No.: US 2014/0033704 A1
(43) Pub. Date: Feb. 6, 2014

(54) CONSTRUCTION VEHICLE WITH WASTE HEAT RECOVERY

(71) Applicant: BOMAG GmbH, Boppard (DE)

(72) Inventors: Robert Laux, Neuwied (DE); Marco Reuter, Emmelshausen (DE)

(73) Assignee: BOMAG GmbH, Boppard (DE)

(21) Appl. No.: 13/953,836

(22) Filed: Jul. 30, 2013

(30) Foreign Application Priority Data
Jul. 31, 2012 (DE) 10 2012 015 267.1

(51) Int. Cl. F02B 27/00

(52) U.S. Cl. CPC F02B 27/00
USPC 60/605.1; 60/597

(57) ABSTRACT

The present invention relates to a construction vehicle comprising a main drive for driving work equipment of the construction vehicle, which main drive comprises at least one internal combustion engine, wherein the construction vehicle comprises an energy converter, which is adapted to convert off gas heat energy from the internal combustion engine to mechanical kinetic energy.

### CROSS-REFERENCE TO RELATED APPLICATIONS

The present application claims priority under 35 U.S.C. §119 of German Patent Application No. 10 2012 015 267.1, filed Jul. 31, 2012, the disclosure of which is hereby incorporated herein by reference in its entirety.

### FIELD OF THE INVENTION

The present invention relates to a construction vehicle, in particular, a landfill compactor (landfill construction), also known as refuse compactor, or a road milling machine (road construction), having a main drive comprising at least one internal combustion engine by means of which at least part of the operating power needed to run the construction vehicle is provided.

### BACKGROUND OF THE INVENTION

Such construction vehicles typically always comprise an engine, in particular, an internal combustion engine, for traction and also for driving working implements such as milling drums, conveyors, hydraulic pumps, compactors, etc., mounted on the construction vehicle. The internal combustion engine produces off gas, resulting from the fuel combustion process, and emits this into the environment. To this end, an exhaust system is provided for the purpose of conducting the off gases generated during the combustion process from the internal combustion engine to the outside environment. As a rule, this off gas has a high temperature when it leaves the construction vehicle or the engine. Energy in the form of heat energy is thus discharged into the environment. As a rule, the energy present in the off gas is not utilized. In modern construction vehicles powered by internal combustion engines, approximately 30% or more of the energy supplied escapes unused in the form of hot off gases.

For economic as well as environmental reasons, this release of unused energy in the form of waste heat into the environment is not ideal. Furthermore, the requirements regarding CO2 emissions and the fuel consumption of construction vehicles are becoming increasingly stricter.

### SUMMARY OF THE INVENTION

It is an object of the present invention to provide a construction vehicle showing improvements in terms of fuel consumption, in which the waste heat from driving engines, in particular, internal combustion engines, can be recycled into the power flow of the construction vehicle.

One aspect of the present invention involves a construction vehicle having an energy converter specifically designed to convert off gas heat energy coming from the internal combustion engine into mechanical kinetic energy. The heat energy contained in the off gases can thus be utilized as energy for powering the construction vehicle itself and/or the working implements of the construction vehicle. This improves the efficiency of the construction vehicle and is conducive to a reduction in power consumption. Another aspect is that, according to one embodiment of the present invention, this principle is to be applied only to a certain type of construction machines, especially those which are typically operated with high engine loads or with a high share of high load or full load intervals of the internal combustion engine. This particularly refers to construction machines which are continuously operated in relatively high load ranges and are accordingly designed for long operation intervals in high load ranges, as is the case especially for construction machines for ground processing such as landfill compactors or road milling machines. High load range particularly refers to the range in which at least 50% of the maximum available motor performance is used for operating the construction machine.

The fundamental principle of a currently relevant energy converter resides in its capacity to capture heat energy from the off gases and then recycle it in a utilizable form as mechanical energy. To this end, the energy converter comprises, in a thermal circuit in which a heat transfer fluid such as water is passed through a circuit having a high pressure side and a low pressure side, a heat exchanger, by means of which heat from the off gas of the internal combustion engine can be transferred to a heat transfer fluid. The heat exchanger is integrated in the exhaust line or exhaust system of the internal combustion engine, wherein use can be made of a number of different configuration principles. For instance, parts of the heat exchanger can be installed directly in the stream of off gas for achieving the most directly possible transfer of heat from the off gas to the heat exchanger. Particularly, as regards retrofitting, however, it has been found to be advantageous when the heat exchanger is installed in the construction vehicle such that it surrounds or at least partially surrounds off gas conducting elements, ideally in direct contact therewith. It has been shown that when the heat exchanger is disposed in a region of the exhaust line in which the off gas conducted therethrough during normal operation and, in particular, during operation of the internal combustion engine at the rated power has an off gas temperature of at least 250° C. and, more particularly, of at least 300° C. The term “exhaust line” is used to designate the means employed for conducting the off gases generated by fuel combustion from the internal combustion engine or from the engine block per se to the environment of the construction vehicle by means of, say, suitable pipelines. The heat exchanger comprises a fluid inlet and a fluid outlet, and the fluid passing through the heat exchanger vaporizes in the heat exchanger due to the heat energy uptake.

Another component of the energy converter is an expansion machine which communicates with the heat exchanger for fluid transportation and by means of which mechanical energy can be generated from the heat energy as the heat transfer medium expands and cools. Such an expansion machine can comprise expansion chambers such as are found in piston/cylinder combinations, in which the expansion of the heat transfer fluid in the piston/cylinder chamber ultimately gives rise to mechanical movement of the piston, as is the case, for example, with a piston expander. Instead of such a displacement machine, the expansion machine may alternatively be a fluid flow engine, in particular, a turbine, for example.

In order to achieve a directional fluid circuit within the energy converter, a pump is provided for the purpose of conveying the heat transfer medium from the heat exchanger to the expansion machine. In principle, the pump can be disposed at virtually any point in the fluid circuit, but it has been found to be particularly preferable to position it immediately upstream of the heat exchanger, as regarded in the direction of flow of the fluid.

A high heat transfer efficiency can be achieved when a condenser is interposed between the expansion machine and the heat exchanger, more particularly between the expansion machine and the pump, in the direction of fluid flow through the thermal circuit. The purpose of the condenser is to liquefy the gaseous heat transfer medium down-stream of the expansion machine. Use can be made of a number of various arrangements for cooling the condenser. Preference is given to the integration of the condenser in an engine coolant circuit, by way of example. The temperature thereof typically ranges from a minimum of 85° C. to a maximum of 110° C. The advantage of this arrangement is that the condenser in the energy converter can be included in a cooling circuit that is generally already present in construction vehicles, which results in a very cost-effective implementation of the present invention. In order to improve the heat energy transfer a step further, it is preferred, in an alternative embodiment, to integrate the condenser in a separate cooling circuit comprising, in particular, a pipe system, a pump, and heat sink elements. In particular, a low-temperature cooling circuit has been found to be ideal. The feature that particularly distinguishes a low-temperature cooling circuit is that it is cooled down to a level in the order of 10 K above the ambient temperature, in other words to 55° C. in the case of an ambient temperature of 45° C. Particular preference is given to an extended utilization of the cooling circuit, more particularly, the low-temperature cooling circuit, for cooling the charge air for the internal combustion engine, by which means the cooling circuit in this embodiment assumes a dual function consisting of “condenser cooling” and “charge air cooling”.

The focus of the present invention is therefore on the use of a thermodynamic cycle in which energy can be drawn from the exhaust line of the construction vehicle and fed back to the construction vehicle elsewhere as mechanical energy. Particularly good results are obtained when the energy converter operates according to the Rankine cycle principle. For an explanation of the fundamentals of this thermodynamic cycle, reference is made to pages D22 and D23 of the 21st edition of DUBBEL, Handbuch fur den Maschinenbau (DUBBEL, Manual of Mechanical Engineering). Essential components are a fluid vaporizer, an expansion machine such as, for example, a fluid flow engine, especially a turbine, or a displacement machine, especially a piston expander, a condenser and a pump, which are connected in a fluid circuit. According to the method of operation, in a first step fluid is vaporized and superheated in the heat exchanger by the supply of off gas heat from the internal combustion engine. The subsequent conversion into mechanical energy is achieved through subsequent expansion of the fluid in the expansion machine, for example, a turbine or a piston expander. The fluid is then condensed and finally pumped through the circuit back to the heat exchanger.

According to the present invention, the construction machine has an internal combustion engine with a motor power rating of more than 200 kW. This performance class of internal combustion engines provides optimal results in terms of economic efficiency and utilization of the energy recovery process. The motor power rating is determined in accordance with ISO 3046-1, which is, in its entirety, incorporated herein by reference.

Preferred aspects of the present invention relate, in particular, to the specific integration of the energy converter in the construction vehicle. For example, coupling of a power take-off of the internal combustion engine to the expansion machine has been found to be advantageous. A drive torque provided by the expansion machine can thus be coupled into the power take-off and utilized. The internal combustion engine and the expansion machine are thus more or less connected in parallel as a drive train. The drive energy of the expansion machine is thus readily implemented without having to configure an additional drive train for the expansion machine. Additionally, a supplementary transmission can be interposed between the expansion machine and the power take-off in order to adapt the output speed of the expansion machine to the speed of the power take-off.

In addition, there are other possible variants regarding the connection of the pump of the energy converter. In order to provide pumping power, a pump drive is required. Preference is given to an arrangement of the pump such that it can be driven by the power take-off. This is achieved, for example, directly via the output shaft of the power take-off or via the supplementary transmission. With this arrangement, a separate drive for the pump is not required. A less complex and therefore more reliable construction vehicle can thus be produced. Furthermore, a more compact arrangement arises, whereby the dimensions of the construction vehicle can be reduced or space for additional working implements be provided.

To operate, for example, onboard monitoring and control systems, lighting equipment, and electric motors for traction and/or for driving working implements, modern construction vehicles, such as, in particular, road milling machines and landfill compactors, frequently show a high consumption of electrical energy. Hence it is advantageous when the energy recovered by the energy converter is available to the construction vehicle as electrical energy. This is preferably achieved by an aspect of the present invention in which the expansion machine is drive-coupled to a generator and drives the latter for the purpose of generating electrical energy.

The electrical energy generated by the generator can also be used, for example, to power the construction vehicle. Specifically for such embodiments, it is ideal when the construction vehicle comprises an electric motor coupled to the internal combustion engine via a power take-off thereof, the electric motor being drivable with the energy generated by the generator. For example, the electric motor is rotatably coupled via its output shaft to the power take-off and thereby applies its drive energy to the power take-off. The energy generated by the expansion machine can thus be simply decoupled, spatially, from the energy input into the power take-off by arranging the generator and the electric motor so as to be disposed spatially apart from each another. Furthermore, extended possibilities in terms of control technology arise, for example, for the purpose of controlling the speed of the electric motor without the use of an additional transmission mechanism.

In particular, it is preferred to interpose a storage unit for electrical energy between the generator and the electric motor. The storage unit comprises, for example, a rectifier and a battery. The energy generated by the generator can thus be stored temporarily and used when needed by the electric motor.

In principle, the basic energy conditions for operating the embodiment of the present invention involving an energy converter can vary over a wide spectrum, wherein optimum energy recovery results are achieved by preferentially operating within specific operating parameters. Preference is given to operation of the energy converter within a range in which an off gas stream of at least 25% of the off gas stream available at the rated output of the internal combustion engine is available. In this context, the off gas stream indicates the mass of off gas of the combustion engine to be discharged or being discharged within a determined period of time measured in mass per time. For example, in a development, provision can be made for the construction vehicle to have a control mechanism that controls the operating performance of the internal combustion engine in such a way that the latter is operated as far as possible within a range that is also optimal for energy recovery. To this end, said control mechanism can monitor certain parameters such as the off gas temperature and/or the operating performance of the internal combustion engine, in particular, and it can regulate, for example, the operation of the internal combustion engine and/or of the energy converter. The control mechanism is ideally part of an energy management system of the construction vehicle, which in addition to energy recovery, monitors and regulates other optimization strategies for reducing the energy requirement of the construction vehicle.

Optimum results with the use of the present energy recovery system are achieved, in particular, with such construction vehicles that provide ideal basic energy conditions for the operation of the energy converter. Thus the construction vehicle is preferably a landfill compactor, a ground milling machine, in particular, a road milling machine, a recycler, a stabilizer or surface miner, or a road paver. In the context of the present invention, preference is therefore given to utilization of the energy recovery system disclosed herein particularly for these types of construction vehicle. Generic examples are the landfill compactors having the type designations BC 672 RB-3 and BC 772 RB-3, which are offered and distributed by the applicant. Self-propelled landfill compactors of this type are characterized by padfoot drums and a clearing shield for processing waste placed on the ground. Generic road milling machines are, for example, offered and distributed by the applicant under type designations BM 1000/30-2, BM 1200/30-2 and BM 2000/30-2. For an example of the fundamental structure and functioning of such road milling machines, reference is made to WO 2013072066 A1. With respect to their respective drive device, landfill compactors and road milling machines are configured for high shares of high load up to full load operation. In this context, full load operation means the maximum performance of the internal combustion engine running at the corresponding speed.

### BRIEF DESCRIPTION OF THE DRAWINGS

The present invention will be explained in more detail below with reference to exemplary embodiments and to the appending drawings, in which:

FIG. 1 is a side view of a preferred type of a construction vehicle, more specifically a road milling machine;

FIG. 2 is a partial view of the construction vehicle as shown in FIG. 1 involving waste heat recovery according to a first exemplary embodiment;

FIG. 3 is a partial view of the construction vehicle as shown in FIG. 1 involving waste heat recovery according to a second exemplary embodiment;

FIG. 4 is a partial view of the construction vehicle as shown in FIG. 1 involving waste heat recovery according to a third exemplary embodiment;

FIG. 5 is a partial view of the construction vehicle as shown in FIG. 1 involving waste heat recovery according to a fourth exemplary embodiment;

FIG. 6 is an elementary diagram illustrating the integration of the condenser in the cooling package of an internal combustion engine;

FIG. 7 is a side view of a landfill compactor;

FIG. 8A is a consumption diagram for a road milling machine; and

FIG. 8B is a consumption diagram for a landfill compactor.

Like components shown in the figures are designated by like reference signs. Not each instance of a component is specifically denoted in all figures.

### DETAILED DESCRIPTION OF THE INVENTION

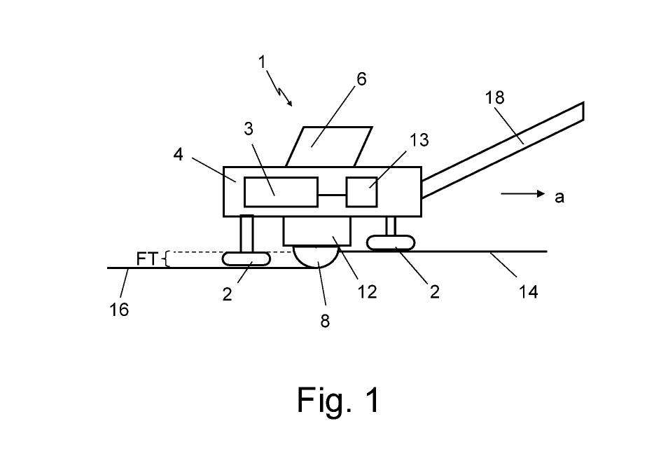

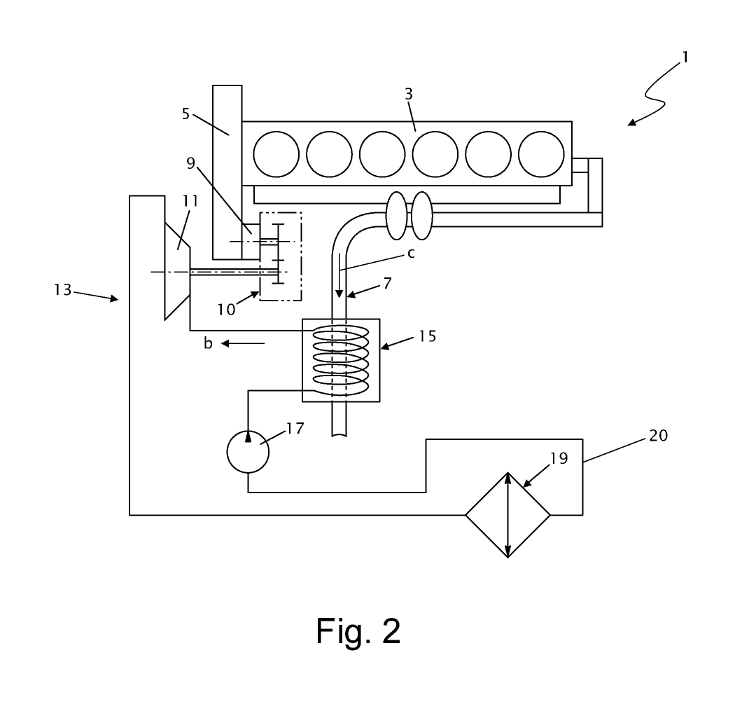

FIG. 1 illustrates the basic construction of an exemplary construction vehicle 1 for ground processing, in this particular case a road milling machine. The construction vehicle 1 in FIG. 1 is configured for milling off an upper layer of the road surface to a milling depth FT. Essential components of the construction vehicle 1 are a machine frame 4, a chassis with a total of four caterpillar tracks 2 mounted on lifting columns on the machine frame 4, the lifting columns being vertically adjustable, an operator station 6 and a working implement, which in this specific case is a milling drum 8 mounted in a drum housing 12. The milling depth FT can be varied by vertically adjusting the lifting columns so that, for example, the distance of the underside of the vehicle down to the road surface is vertically variable. The milling drum 8 is disposed in the horizontal plane with its axis of rotation R perpendicular to the machine direction “a” of the construction vehicle 1. In the working mode, the milling drum 8 digs into the road surface 14 and, as the construction vehicle 1 moves in the machine direction “a”, mills off ground material from the road surface 14 to a milling depth FT, thus leaving a milled surface 16. The milled-off material is transported from the drum housing 12 and away from the construction vehicle 1 by a conveying mechanism in the form of a conveyor belt 18 and discharged into, say, a suitable transport container of a transport vehicle, for example. To generate the energy for the traction drive and for operating the working implements (milling drum 8, conveyor belt 18, lifting columns, etc.), the construction vehicle 1 comprises a powerful internal combustion engine 3 with a motor power rating of more than 200 kW. The construction vehicle 1 is thus self-powered. According to one embodiment of the present invention, an energy converter 13 is additionally provided, which captures heat energy from the exhaust line of the internal combustion engine 3 and feeds it back to the construction vehicle 1 in the form of mechanical and/or electrical energy. The following FIGS. 2 to 5 illustrate alternative embodiments of the energy converter 13 and, more particularly, the connection thereof to the internal combustion engine 3.

FIG. 2 is a partial view of a construction vehicle 1 involving exhaust heat recovery according to a first exemplary embodiment. The construction vehicle 1 has an internal combustion engine 3 for powering working implements, for example, the milling drum 8 for road work and/or the traction drive. The internal combustion engine 3 herein is equipped with a flywheel housing 5 for the accommodation of a flywheel to enable the internal combustion engine to operate more smoothly. On one side, the flywheel housing 5 is disposed at the head end of the internal combustion engine 3. Extending away from the internal combustion engine 3 is an exhaust line 7 for discharging off gases from the internal combustion engine 3 in the direction of the arrow “c”, which exhaust line is only shown at its end adjoining the internal combustion engine 3 in FIG. 2, although it in fact continues to the environment via the outer edge of the machine frame 4 in a manner not shown in greater detail. In the illustrated area of the exhaust system 7, the off gas has an off gas temperature of at least 250° C. when the internal combustion engine 3 is running, particularly in the normal mode, more specifically in the working mode, and, more particularly, at the rated output. This range is detectable by suitable measurements on the vehicle and can, optionally and in a manner not illustrated in the figures, be further monitored by means of a temperature sensor for measuring and monitoring the off gas temperature. Furthermore, according to a preferred aspect, the values determined by the temperature sensor can be transmitted to a control unit, which unit, as part of an energy converter 13 described in more detail below, controls the energy recovery process and/or the operation of the energy converter. Additionally, a power take-off 9 is connected to the internal combustion engine 3 via the flywheel housing 5. The purpose of the power take-off 9 is to supply the mechanical energy recovered, by means of an expansion machine 11, from the off gases of the internal combustion engine 3. To this end, in this exemplary embodiment a supplementary transmission 10 is superimposed on the power take-off 9. By means of the supplementary transmission 10, the speed of the output of the expansion machine 11 can be varied to match the desired input speed of the working implements to be powered.

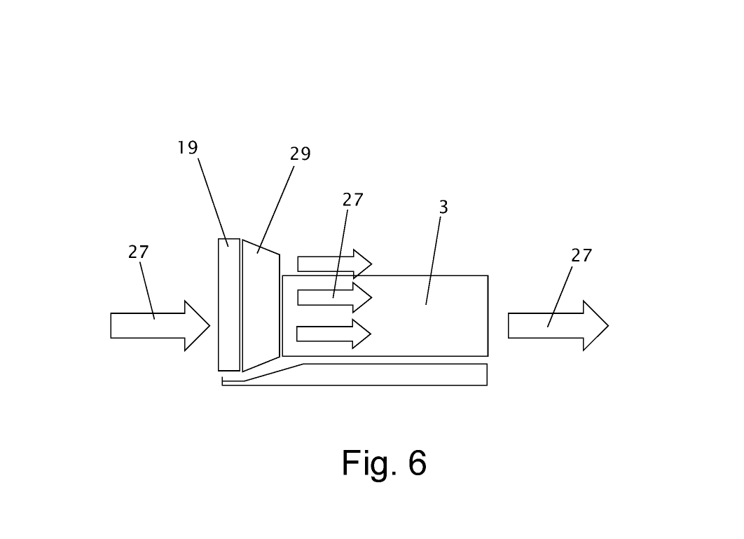

The expansion machine 11, which, in particular, can be a turbine or a piston expander, is part of the energy converter 13, which converts heat energy from the off gases of the internal combustion engine 3 to mechanical energy and utilizes it, via the power take-off 9, on the working implements of the construction vehicle 1, e.g., the traction drive and/or the milling drum 8. On the exhaust line 7 there is provided a heat exchanger 15, which is helically wound around a region of the exhaust line 7 near the engine in which the off gas temperature under the aforementioned conditions is at least 250° C. The purpose of the heat exchanger 15 is to transfer heat energy from the off gases of the internal combustion engine 1 to a heat transfer fluid (e.g., water), which is fed through a circuit within the energy converter 13 in the fluid flow direction “b”. A pump 17 inserted in the fluid circuit 20 forces the heat exchanger fluid via a conduit system of the fluid circuit 20 to the heat exchanger 15 so that the heat exchanger fluid can absorb heat energy from the off gases in the exhaust line and is thus heated and, depending on the embodiment, vaporized and superheated. This side of the fluid circuit between the pump 17 and the expansion machine 11 is the high pressure side of the fluid circuit. The heat transfer fluid coming from the heat exchanger 15 is conducted to the expansion machine 11. The expansion machine 11 operates with, for example, turbine elements, which enable the energy of the compressed heated heat transfer medium expanding in the expansion machine 11 to be converted to mechanical kinetic energy. Recirculation of the heat transfer fluid cooled in the expansion machine 11 back to the pump 17 takes place on the low pressure side via a condenser 19, which is integrated in, for example, a cooling package of the construction vehicle 1, as illustrated in more detail in FIG. 6. The heat transfer fluid is, for example, completely liquefied in the condenser 19 for recirculation back to the pump 17 in order to build up pressure.

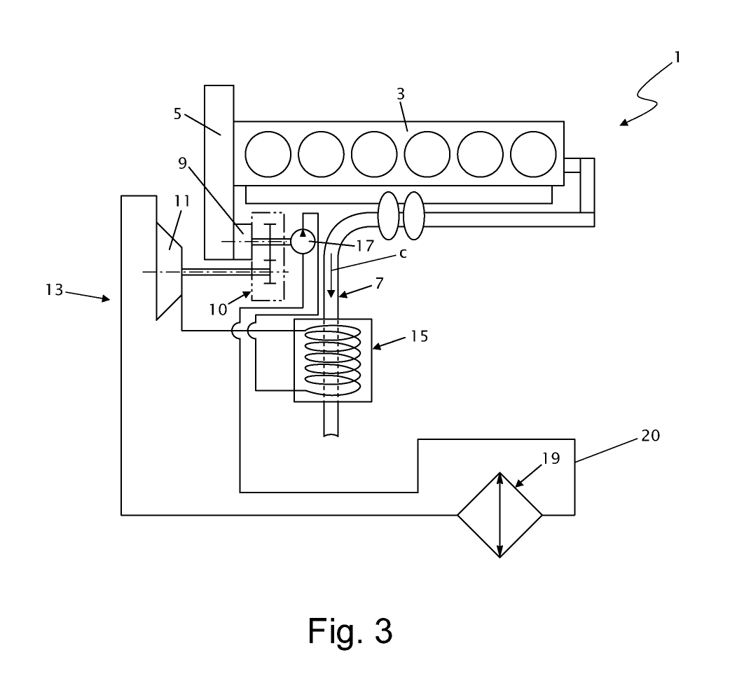

FIG. 3 illustrates an alternative embodiment of the energy converter 13. The essential difference between this and the exemplary embodiment shown in FIG. 2 is the arrangement of the pump 17. Here the pump 17 for compressing the medium is disposed directly on the power take-off 9 and can be driven by the power take-off 9. This is achieved, for example, directly by the output shaft of the power take-off 9 or via the supplementary transmission 10. This has the advantage that no extra drive for the pump 17 is required.

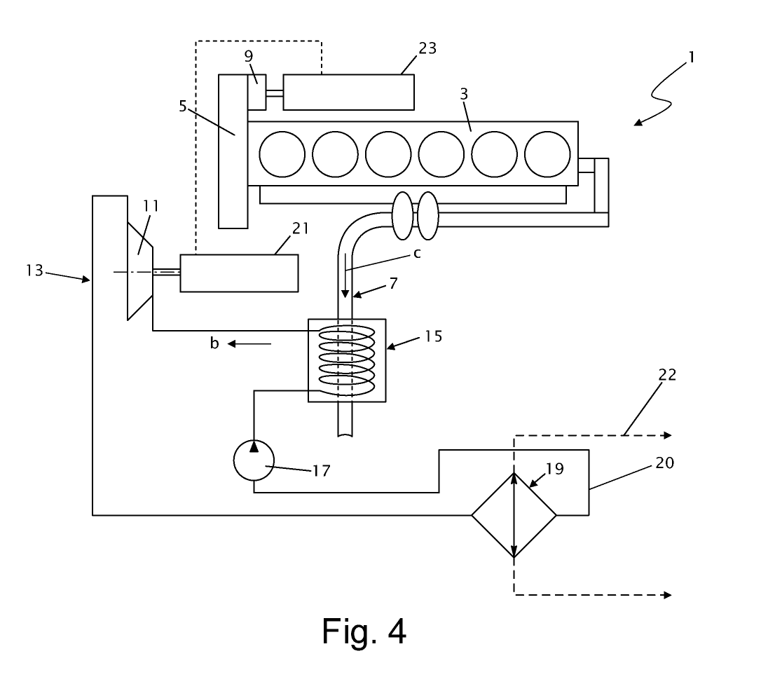

In the embodiments shown in FIGS. 2 and 3, the drive connection between the output shaft of the expansion machine and the power take-off 9 of the internal combustion engine 3 is purely mechanical. The embodiment illustrated in FIG. 4 follows an alternative concept. In this exemplary embodiment, a generator 21 is powered by the expansion machine 11. The generator 21, powered by the expansion machine 11, generates electrical energy. On the power take-off 9 there is disposed an electric motor 23, which is driven by the electrical energy generated by the generator 21 and supplies its drive energy to the power take-off 9. To this end, the output shaft of the electric motor 23 is connected to, for example, a drive shaft of the power take-off 9. Thus a characteristic feature of this alternative embodiment is, in particular, that the energy conversion takes place in three phases: a) recovering heat in order to drive the expansion machine for the production of mechanical energy, b) generating and conducting electrical energy by a generator 21 driven by the expansion machine and driving an electric motor by the generated electrical energy, and c) generating mechanical energy by the electric motor and supplying mechanical energy to the power take-off of an internal combustion engine. This exemplary embodiment makes it possible in a simple manner to spatially decouple the energy generated by the expansion machine 11 from the energy supplied to the power take-off 9 in that the generator 21 and the electric motor 23 can be disposed spatially apart from each other. Furthermore, extended possibilities in terms of control technology arise, for example, for the purpose of controlling the speed of the electric motor 23 without the use of an additional transmission mechanism.

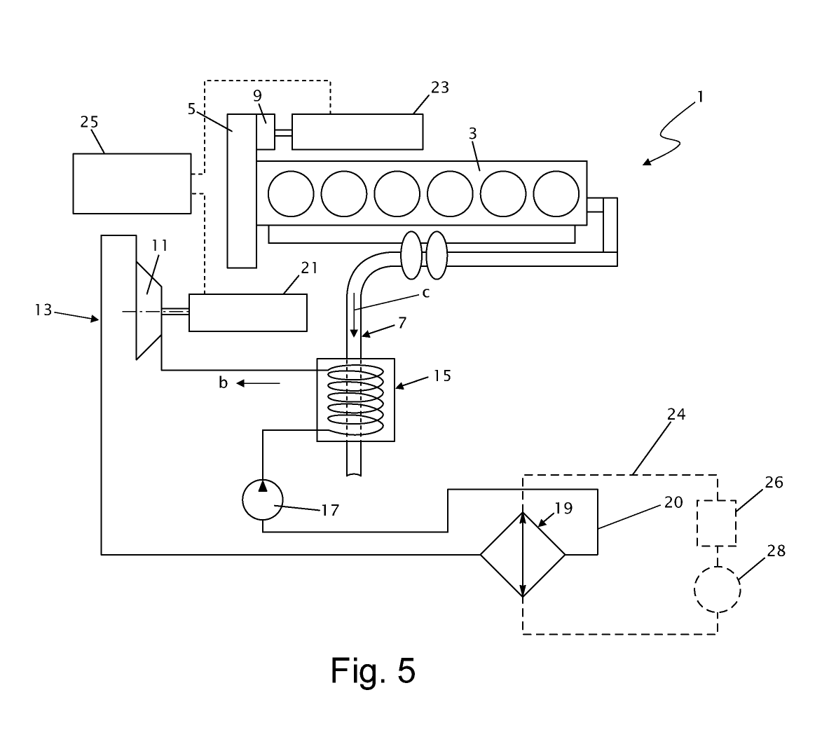

Finally, FIG. 5 is to be understood as a development of the embodiment shown in FIG. 4 and is augmented by a storage unit 25 disposed between the generator 21 and the electric motor 23. The electrical energy generated by the generator 21 can thus be temporarily stored and used when needed by the electric motor 23. This provides additional flexibility in the energy management of the generator 21 and the electric motor 23.

FIGS. 4 and 5 further illustrate two optional and preferred developments of the condenser 19, which can also be used in this form with the embodiments illustrated in FIGS. 2 and 3 and also interchangeably. In FIG. 4, the condenser 19 is integrated in an engine coolant circuit 22, which is merely indicated in FIG. 4 and of which only the corresponding branch lines are shown. In FIG. 5, however, the condenser 19 is integrated in a separate cooling circuit 24 comprising a heat sink 26 and a pump 28. In addition to the coolant circuit (not shown in FIG. 5) for the internal combustion engine 3, a second cooling circuit 24 is provided operated independently of the engine coolant circuit. In this specific embodiment, the cooling circuit is configured as a low-temperature cooling circuit, thereby achieving particularly efficient cooling of the heat transfer fluid of the energy converter 13 and thus a particularly efficient heat transfer in the heat exchanger 15. In this embodiment, the low-temperature cooling circuit 24 is provided downstream of the condenser, as regarded in the direction of flow of the cooling fluid, for the purpose of intercooling the internal combustion engine 3.

Finally, the purpose of FIG. 6 is to illustrate the basic arrangement of the condenser 19 in the construction vehicle 1. The internal combustion engine 3 is supplied with cooling air 27 coming from an upstream side, as indicated by the arrow. The cooling air 27 initially flows through a cooling package 29 and subsequently flows past the internal combustion engine 3. In this exemplary embodiment, the condenser 19 is combined with the previous cooling package 29 and disposed upstream thereof, as regarded in the direction of flow of the cooling air. The cooling air thus initially passes through the condenser 19, then through the cooling package 29, and finally along the internal combustion engine 3. Optimum performance results are achieved with this arrangement. Furthermore, a particularly compact design is achieved thereby, so that the space required for the integration of the condenser 19 is comparatively small.

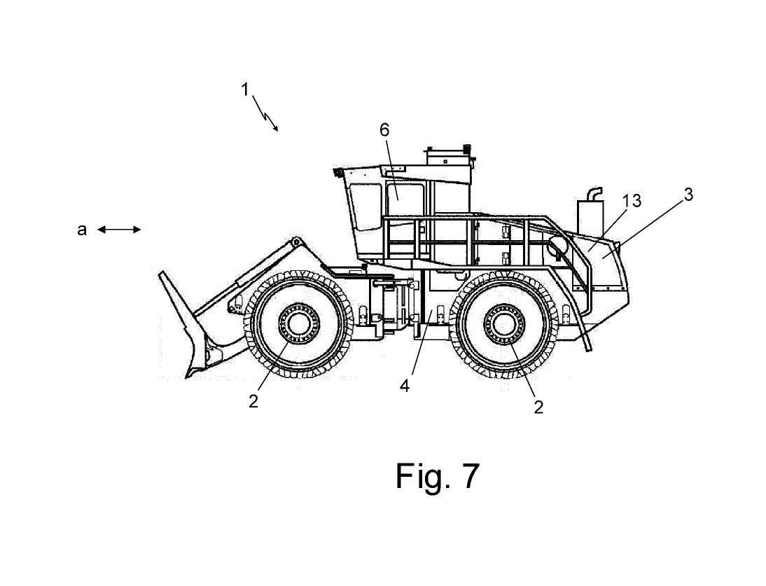

FIG. 7 shows a construction vehicle 1 configured as an exemplary landfill compactor as an alternative to the road milling machine shown in FIG. 1. Essential elements of the landfill compactor shown in FIG. 7 are likewise a machine frame 4, an operator station 6 and a powerful internal combustion engine 3 with a motor power rating of more than 200 kW. The chassis of the landfill compactor comprises a total of four moving devices 2 arranged as padfoot drums crushing and compacting ground material as the landfill compactor travels along the machine direction a. Supplementary, an energy converter 13 which captures heat energy from the exhaust line of the internal combustion engine 3 and feeds it back to the construction machine 1 in the form of mechanical and/or electrical energy. With respect to further details of the landfill compactor and, in particular, the configuration of the energy converter 13, reference is made to the above description regarding FIGS. 2 to 6.

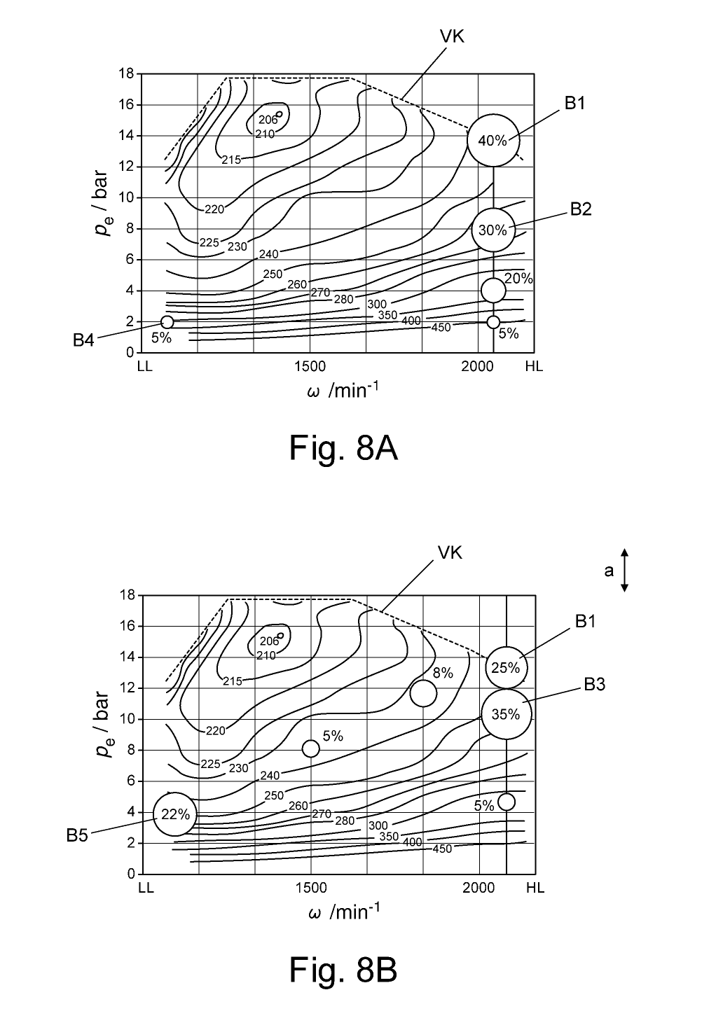

FIGS. 8A and 8B show consumption diagrams for a road milling machine (FIG. 8A) and a landfill compactor (FIG. 8B). In said consumption diagrams, the respective abscissa designates the motor speed w in rounds per minute, while the respective ordinate designates the mean effective pressure pₑ of the internal combustion engine in bar. The curves illustrate the specific fuel consumption in grams of fuel per kilowatt hour. VK designates the so-called full load curve. Further, the high load shares, i.e., those ranges in which the engine is operated at least at 50% of the maximum available motor performance, are shown in percent in each respective consumption diagram. FIGS. 8A and 8B illustrate that road milling machines and landfill compactors have a particularly high percentage, specifically more than 50%, of high load intervals in practice. This is indicated in FIGS. 8A and 8B by operation (time) percentages B1, B2 and B3, which, unlike, for example, percentages B4 and B5, are within the high load range. Due to these operation conditions being present in practice, a large amount of waste heat is released by the exhaust line and accordingly particularly efficient and cost-effective use of the energy recovery system described above is made possible.

While the present invention has been illustrated by description of various embodiments and while those embodiments have been described in considerable detail, it is not the intention of Applicant to restrict or in any way limit the scope of the appended claims to such details. Additional advantages and modifications will readily appear to those skilled in the art. The invention in its broader aspects is therefore not limited to the specific details and illustrative examples shown and described. Accordingly, departures may be made from such details without departing from the spirit or scope of Applicants' invention.

What is claimed is:

1. A construction vehicle for ground processing, comprising:
a main drive including at least one internal combustion engine with a motor power rating of more than 200 kW, by means of which at least part of the driving energy necessary for the operation of the construction vehicle is made available,
wherein the construction vehicle comprises an energy converter that operates according to a Rankine cycle principle and is adapted to convert off gas heat energy from the internal combustion engine to mechanical kinetic energy, comprising
a heat exchanger in a thermal cycle, wherein heat contained in off gas of the internal combustion engine can be transferred by means of said heat exchanger to a heat transfer medium, and wherein the heat exchanger is disposed in a region of an off gas guide means, in which the off gas has a temperature of at least 250° C.,
an expansion machine by means of which mechanical kinetic energy can be produced on cooling of said heat transfer medium,
a pump for the purpose of conveying said heat transfer medium from said heat exchanger to said expansion machine, and
a condenser disposed in said thermal cycle of said energy converter between said expansion machine and said pump.

2. The construction vehicle according to claim 1, wherein said expansion machine is coupled to a power take-off of said internal combustion engine.

3. The construction vehicle according to claim 2, wherein a supplementary transmission is interposed between said expansion machine and said power take-off.

4. The construction vehicle according to claim 2, wherein said pump is drivable by said power take-off.

5. The construction vehicle according to claim 1, wherein a generator is coupled to said expansion machine and an electric motor is provided which is rotatably coupled to said internal combustion engine and which is drivable by means of the energy produced by the generator.

6. The construction vehicle according to claim 5, wherein said electric motor is coupled to said power take-off.

7. The construction vehicle according to claim 5, wherein an energy storage device is interposed between said generator and said electric motor.

8. The construction vehicle according to claim 1, wherein said energy converter is operated in a region in which an off gas mass flow of at least 25% of the off gas mass flow available under the rated power of said internal combustion engine is available.

9. The construction vehicle according to claim 1, wherein said condenser is integrated in an engine coolant circuit, in its own cooling circuit, or in a low-temperature circuit.

10. The construction vehicle according to claim 1, wherein the construction vehicle comprises a landfill compactor or a road milling machine.

11. The construction vehicle according to claim 3, wherein said pump is drivable by said power take-off.

12. The construction vehicle of claim 7, wherein the energy storage device comprises a battery.
